(19) United States
(12) Patent Application Publication
(10) Pub. No.: US 2004/0103267 A1
(43) Pub. Date: May 27, 2004

(54) Data processor having cache memory

(75) Inventor: Yukari Takata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., TOKYO (JP)

(21) Appl. No.: 10/624,838

(22) Filed: Jul. 23, 2003

(30) Foreign Application Priority Data
Jul. 25, 2002 (JP) 2002-216769

(51) Int. Cl. G06F 9/00

(52) U.S. Cl. 712/225; 712/244; 712/228

(57) ABSTRACT

Provided is a data processor capable of preferentially starting an interrupt processing when an interrupt request occurs during burst transfer to cache memory. When an interrupt request (IR) is detected during burst transfer to an instruction cache (3), the instruction cache (3) suspends the burst transfer and creates break information (35). Upon return to the original program at the termination of the interrupt processing, the instruction cache (3) restarts the burst transfer from the suspended point by referring to a restart address described in an address description part (35a) of the break information (35).

### BACKGROUND OF THE INVENTION

1. Field of the Invention

The present invention relates to a data processor and, in particular, to a data processor having cache memory.

2. Description of the Background Art

In a data processor having cache memory, when data required by a CPU does not exist in the cache memory, data corresponding to one line of the cache memory, including the data required, are transferred from main memory to a certain line of the cache memory. For example, when one line of the cache memory is 128 bits and the cache memory is connected to the main memory with a 32-bit data bus, data are transferred from the main memory to the cache memory by four bus cycles. Data corresponding to one line of the cache memory are consecutively transferred by burst transfer.

### SUMMARY OF THE INVENTION

Conventional data processors suffer from the following problems. When an interrupt request occurs during burst transfer, an interrupt processing is started after the completion of the burst transfer. Therefore, a response to the interrupt request is late. Likewise, when a branch instruction to other program is detected during burst transfer, an instruction fetch of a branch target program is started after the completion of the burst transfer. Therefore, the execution of the branch target program is late. Further, if not returning to the original program at the completion of the interrupt processing, or at the completion of the execution of the branch target program, unnecessary data exist in the cache memory.

It is an object of the present invention to provide a data processor capable of preferentially starting an interrupt processing when an interrupt request occurs during burst transfer from main memory to cache memory.

According to a first aspect of the present invention, a data processor includes a processor, a first storage device, and a second storage device connected between the processor and the first storage device. When a predetermined data required by the processor does not exist in the second storage device, a plurality of data corresponding to one line of the second storage device, including the predetermined data, are read from the first storage device and transferred to a certain line of the second storage device by burst transfer. When an interrupt request occurs during the burst transfer, the burst transfer is suspended and an interrupt processing is started.

An interrupt processing to an interrupt request of high urgency can be started immediately.

According to a second aspect of the present invention, a data processor processing instructions in pipeline having an instruction fetch stage fetching the instructions from a memory, a decode stage decoding the instructions fetched by the fetch stage, and an instruction execution stage executing the instructions decoded by the decode stage.

In the data processor, when an interrupt request occurs, an interrupt process is performed in response to the interrupt request. Then, first and second processes are selectively performed as the interrupt process in accordance with a priority assigned to the interrupt request.

In the first process, the instruction execution stage executes an interrupt instruction corresponding to the interrupt request after executing an instruction that is already fetched before the interrupt instruction is fetched by the instruction fetch stage. In the second process, the instruction stage executing the interrupt instruction before executing an instruction that is already fetched before the interrupt instruction is fetched by the instruction fetch stage and that is not yet executed by the instruction execution stage.

An interrupt which needs an urgent interrupt processing can be started immediately by suspending the instruction that is already fetched. On the other hand, if the priority of an interrupt request is not so high, an interrupt handler is executed after executing the instruction that is already fetched before interrupt. Therefore, the processing proceeds without disturbing pipeline, and the penalty caused by the interrupt processing can be eliminated.

According to a third aspect of the present invention, a data processor includes a processor, a first storage device, and a second storage device connected between the processor and the first storage device. When a predetermined data required by the processor does not exist in the second storage device, a plurality of data corresponding to one line of the second storage device, including the predetermined data, are read from the first storage device and transferred to a certain line the second storage device by burst transfer. When a first branch instruction is detected during a first burst transfer in the process of executing a first program, the first burst transfer is suspended and a second program as a branch target is executed. If the second program is a program having a high possibility of returning to the first program, first information to restart suspended burst transfer is saved. Upon completion of the second program, the first burst transfer suspended is restarted based on the first information.

When the first branch instruction is detected during the first burst transfer, the first burst transfer is forced to suspend and the second program is preferentially executed, without waiting for completion of the first burst transfer. Therefore, the second program can be started immediately.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a data processor according to a first preferred embodiment of the present invention;

FIG. 2 is a block diagram showing an instruction cache and SDRAM controller;

FIG. 3 is a block diagram showing the configuration of the instruction cache;

FIG. 4 is a block diagram showing the configuration of an external access request generator circuit;

FIG. 5 is a block diagram showing the configuration of a request count circuit;

FIG. 6 is a bock diagram showing the configuration of an address generator circuit;

FIG. 7 is a block diagram showing the configuration of an instruction code selector circuit;

FIG. 8 is a block diagram showing the configuration of a request cancel signal generator circuit;

FIGS. 9 and 10 are timing charts showing signal and data transition in the data processor of the first preferred embodiment;

FIG. 11 is a diagram showing break information;

FIG. 12 is a schematic diagram showing a first processing flow when an interrupt request occurs during execution of main program;

FIG. 13 is a schematic diagram showing a second processing flow when an interrupt request occurs during the main program execution;

FIG. 14 is a schematic diagram showing a third processing flow when an interrupt request occurs during the main program execution;

FIG. 15 is a timing chart showing signal and data transition in a data processor according to a second preferred embodiment of the invention

FIG. 16 is a schematic diagram showing an example of pipeline processing;

FIG. 17 is a block diagram showing the configuration of an address generator circuit according to a third preferred embodiment;

FIG. 18 is a block diagram showing the configuration of an external access request generator circuit of the third preferred embodiment of the invention;

FIGS. 19 and 20 are diagrams showing a situation where pipeline processing is executed;

FIG. 21 is a timing chart showing signal and data transition in a data processor of the third preferred embodiment;

FIG. 22 is a block diagram showing the configuration of a circuit for generating a RTE detection signal;

FIG. 23 is a schematic diagram showing the configuration of a storage part of an instruction cache according to a fourth preferred embodiment of the invention;

FIG. 24 is a block diagram showing the configuration of a data processor according to a fifth preferred embodiment of the invention;

FIG. 25 is a block diagram showing the configuration of an instruction cache of the fifth preferred embodiment;

FIG. 26 is a block diagram showing the configuration of an interrupt permission judgment circuit;

FIG. 27 is a block diagram showing a first configuration of an ICU of the fifth preferred embodiment;

FIG. 28 is a block diagram showing a second configuration of the ICU of the sixth preferred embodiment; and

FIG. 29 is a schematic diagram showing a stack region in a data processor according to a fifth preferred embodiment.

### DESCRIPTION OF THE PREFERRED EMBODIMENTS

### First Preferred Embodiment

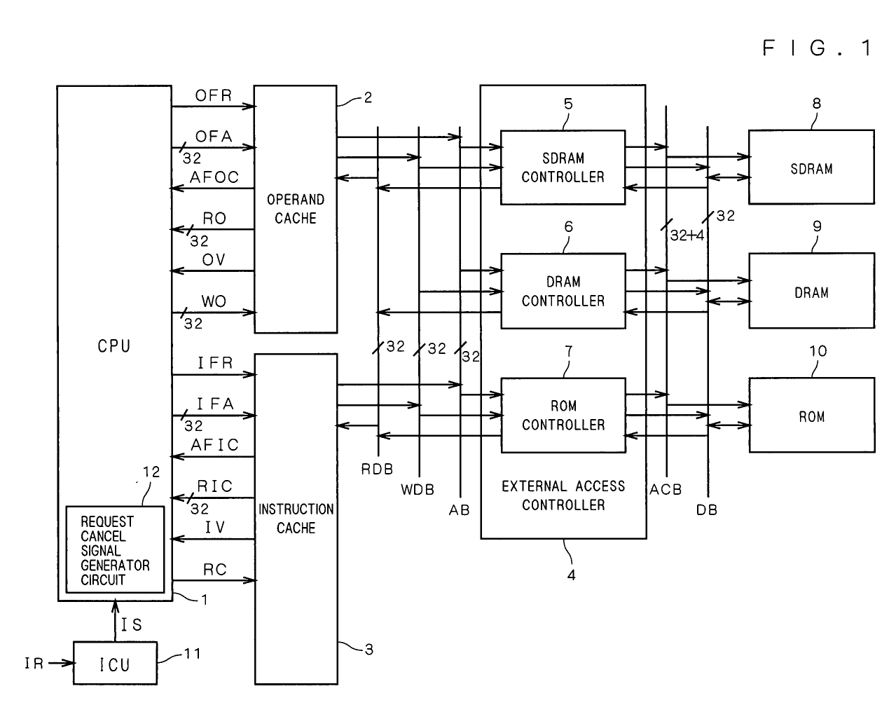

FIG. 1 is a block diagram showing the configuration of a data processor according to a first preferred embodiment of the present invention. Referring to FIG. 1, this data processor comprises a CPU 1, an operand cache (generally being called “data cache”) 2, and an instruction cache 3. The CPU 1 has a request cancel signal generator circuit 12. The data processor further comprises a controller (external access controller) 4 for controlling access to external memory (SDRAM 8, DRAM 9, and ROM 10). The external access controller 4 has a SDRAM controller 5, a DRAM controller 6, and a ROM controller 7. The data processor still further comprises an interrupt controller (ICU) 11 that accepts an interrupt request IR from a module disposed outside or inside of the data processor, and also inputs an interrupt signal IS to the CPU 1.

Following is signals to be given and received between the CPU 1 and instruction cache 3. An instruction fetch request signal IFR is a signal indicating that the CPU 1 requests an instruction fetch from the instruction cache 3. Instruction address signals IFA indicate the address of an instruction code required by the CPU 1. A receipt signal AFIC is a signal indicating that the instruction cache 3 accepts the instruction fetch request from the CPU 1. Instruction codes RIC are transferred from the instruction cache 3 to the CPU 1. An instruction valid signal IV is a signal indicating that a valid instruction code is transferred from the instruction cache 3 to the CPU 1. A request cancel signal RC is a signal indicating a burst transfer break request. Each of the instruction address signal IAF and the instruction code RIC is a 32-bit bus signal.

Following is signals given and received between the CPU 1 and operand cache 2. An operand fetch request signal OFR is a signal indicting that the CPU 1 requests an operand fetch from the operand cache 2. An operand address signal OFA is a signal indicating the address of an operand required by the CPU 1. A receipt signal AFOC is a signal indicating that the operand cache 2 accepts the operand fetch request from the CPU 1. A read operand RO is an operand that is transferred from the operand cache 2 to the CPU 1. An operand valid signal OV is a signal indicating that a valid operand is transferred from the operand cache 2 to the CPU 1. A write operand WO is an operand that is transferred from the CPU 1 to the operand cache 2. Each of the operand address signal OFA, the read operand RO and the write operand WO is a 32-bit bus signal.

A description will now be given of the data processor according to the present invention, taking aim at the relationship between the instruction cache 3 and SDRAM controller 5. The relationship between the instruction cache 3 and DRAM controller 6 or ROM controller 7, as well as the relationship between the operand cache 2 and SDRAM controller 5, DRAM controller 6, or ROM controller 7, are basically the same, and a full description thereof is omitted here.

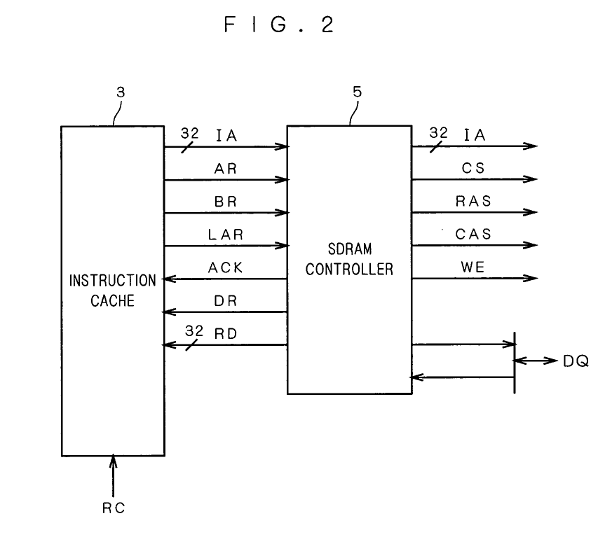

FIG. 2 is a block diagram showing the instruction cache 3 and SDRAM controller 5. Following is signals given and received between the instruction cache 3 and SDRAM controller 5. An address signal IA is a signal that indicates the address of an instruction code required by the CPU 1 and that is inputted from the instruction cache 3 to the SDRAM controller 5 via an address bus AB shown in FIG. 1. A bit wide of the address bus AB is 32 bits in this example. An access request signal AR is a signal indicating that the instruction cache 3 requests access to the SDRAM 8. A burst request signal BR is a signal requiring that data be transferred from the SDRAM 8 to the instruction cache 3 by burst transfer. When the burst request signal BR is “H (high)”, burst transfer is designated, and when it is “L (low)”, one-shot transfer is designated.

A last request signal LAR is valid when burst transfer is designated, and is a signal indicating the last access request in the burst transfer. An acknowledge signal ACK is a signal indicating that the SDRAM controller 5 accepts an access request from the instruction cache 3. A data ready signal DR is a signal indicating that a valid data is transferred from the SDRAM controller 5 to the instruction cache 3. A read data RD is data transferred from the SDRAM controller 5 to the instruction cache 3 via a data bus RDB shown in FIG. 1. A bit wide of the data bus RDB is 32 bits in this example. The data bus WDB transfers data from the operand cache 2 and the instruction cache 3 to each of memories 8, 9 and 10 for writing to each of memories 8, 9 and 10. A bit wide of the data bus WDB is 32 bits in this example. The read data RD is a 32-bit bus signal.

The SDRAM controller 5 inputs an address signal IA and control signals CS, RAS, CAS, and WE to the SDRAM 8 via an address control bus ACB shown in FIG. 1. In this example, a bit wide of the address control bus ACB is 36 bits in total including 32 bits for transferring the address signal IA and 4 bits for transferring the control signals CS, RAS, CAS and WE. Further, data DQ are given and received between the SDRAM controller 5 and SDRAM 8, via a data bus DB shown in FIG. 1. A bit wide of the data bus DB is 32 bits in this example. Each of the address signal IA and the data DQ is a 32-bit bus signal.

FIG. 3 is a block diagram showing the configuration of instruction cache 3. The instruction cache 3 comprises an external access request generator circuit 15, an instruction code selector circuit 16, and a storage part 17. The storage part 17 is divided into a plurality of lines, each having a tag part 17a, a valid bit 17b, and a data part 17c. The data part 17c stores cache-recorded data (recorded data), and the tag part 17a stores tag information of the recorded data. The tag part 17a and data part 17c are valid only for lines on which the valid bit 17b is “H”.

An instruction fetch request signal IFR, request cancel signal RC, instruction address signal IFA, acknowledge signal ACK, hit signal HIT, and miss-hit signal MISS are inputted to the external access request generator circuit 15. When an instruction code required by the CPU 1 exists in the instruction cache 3 (i.e., in the case of “hit”), the hit signal HIT becomes “H” and the miss-hit signal MISS becomes “L”. On the other hand, when the instruction code required by the CPU 1 does not exist in the instruction cache 3 (i.e., in the case of “miss-hit”), the miss-hit signal MISS becomes “H” and the hit signal HIT becomes “L”. An address signal IA, access request signal AR, burst request signal BR, last request signal LAR, and valid data signal SS are outputted from the external access request generator circuit 15. The valid data signal SS will be described later.

An instruction fetch request signal IFR, valid data signal SS, hit signal HIT, and miss-hit signal MISS are inputted to the instruction code selector circuit 16. In the case of “hit”, an instruction code IC read from the data part 17c is inputted to the instruction code selector circuit 16. In the case of “miss-hit,” an instruction code IC read from the SDRAM 8 is inputted to the circuit 16. An instruction code RIC is outputted from the instruction code selector circuit 16.

An instruction address signal IFA and an instruction code IC are inputted to the storage part 17. A hit signal HIT, miss-hit signal MISS, and instruction code IC are outputted from the storage part 17.

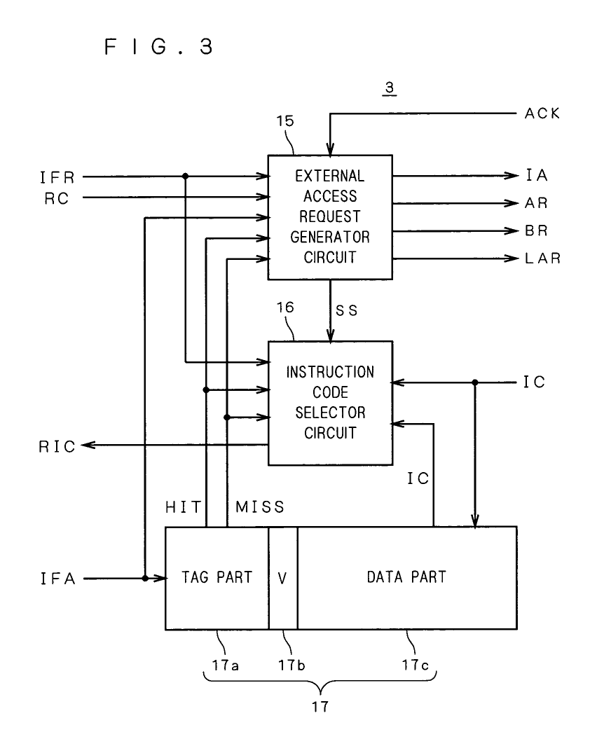

FIG. 4 is a block diagram showing the configuration of the external access request generator circuit 15 shown in FIG. 3. The external access request generator circuit 15 comprises an address generator circuit 20, a request count circuit 21, a request generator circuit 22, inverters 70 and 71, AND circuits 72 and 73, and an OR circuit 74. Break information 35 and instruction address signal IFA are inputted to the address generator circuit 20. The break information 35 will be described later. An address signal IA and valid data signal SS are outputted from the address generator circuit 20. When performing burst transfer, the address generator circuit 20 increments an address indicated by the address signal IA, depending on the bus size of the data bus RDB shown in FIG. 1.

Break information 35, instruction address signal IFA, valid data signal SS, and acknowledge signal ACK are inputted to the request count circuit 21. Signals F1 and F2, which will be described later, are outputted from the request count circuit 21.

A signal F1, an instruction fetch request signal IFR, a miss-hit signal MISS, a hit signal HIT inverted by the inverter 70, and a request cancel signal RC inverted by the inverter 71 are inputted to the request generator circuit 22. An access request signal AR is outputted from the request generator circuit 22. In the case of “miss-hit,” the request generator circuit 22 outputs an access request signal AR. In the case of “hit”, the circuit 22 will not output the access request signal AR.

An instruction fetch request signal IFR and signal CO are inputted to the AND circuit 72. The signal CO is a signal that becomes “H” when the instruction cache 3 is in cache-on state (i.e., the state that the instruction cache 3 is usable). A burst request signal BR is outputted from the AND circuit 72.

The burst request signal BR and signal F2 are inputted to the AND circuit 73. An output signal of the AND circuit 73, and a request cancel signal RC are inputted to the OR circuit 74. A last request signal LAR is outputted from the OR circuit 74.

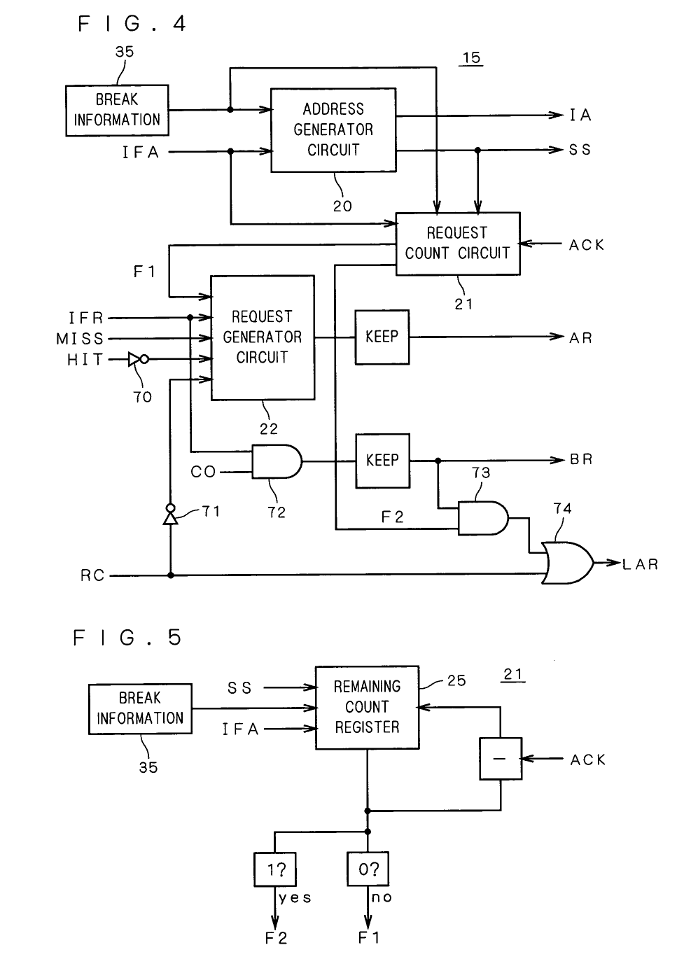

FIG. 5 is a block diagram showing the configuration of the request count circuit 21 shown in FIG. 4. The request count circuit 21 has a counter 25. Based on a valid data signal SS, break information 35, and instruction address signal IFA, the number of the remaining burst transfers (i.e., the remaining count) is set to the counter 25. This remaining count is decremented one by one every time an acknowledge signal ACK is inputted. The signal F1 maintains “H” until the remaining count becomes “0”, and it becomes “L” when the remaining count is “0”. The request generator circuit 22 shown in FIG. 4 deasserts access request signal AR when a signal F1 inputted from the request count circuit 21 becomes “L”.

The signal F2 maintains “L” until the remaining count becomes “1”, and it becomes “H” when the remaining count is “1”. The AND circuit 73 and OR circuit 74 shown in FIG. 4 output the last request signal LAR when the signal F2 is changed from FIG. 6 is a block diagram showing the configuration of the address generator circuit 20 shown in FIG. 4. The address generator circuit 20 comprises a compare circuit 30, a selector circuit 31, a decoder 32, AND circuits 80 to 83, and 85, and an OR circuit 84. The 0th to 27th bits (hereinafter referred to as a “0:2”) of an instruction address signal IFA of a predetermined bit number (assuming 32 bits in this instance) are inputted to one input terminal of the compare circuit 30, and a restart address described in an address description part 35a of the break information 35 is inputted to the other input terminal. Details of the break information 35 will be given later. When the data inputted to the one input terminal matches the data inputted to the other input terminal, the compare circuit 30 outputs a detection result of “H”. On the other hand, when the two data do not match, the circuit 30 outputs a detection result of “L”.

An instruction address signal IFA and a restart address of break information 35 are inputted to the selector circuit 31. When the detection result outputted from the compare circuit 30 is “H”, the selector circuit 31 selects the restart address of the break information 35. On the other hand, when it is “L”, the selector circuit 31 selects the instruction address signal IFA and outputs it as an address signal IA.

Bits [28:29] of the instruction address signal IFA are inputted to the decoder 32. When the IFA [28:29] is “00”, the decoder 32 inputs “H” to one input terminal of the AND circuit 80. Likewise, when the IFA [28:29] are “01”, “10”, or “11”, “H” is inputted to the respective one input terminals of the AND circuits 81, 82, and 83.

“H” or “L” is inputted to the other input terminal of the AND circuit 80, in accordance with the contents of the 0th bit of a data location description part 35b of the break information 35. Concretely, “H” is inputted when the 0th bit is “1”, and “L” is inputted when the 0th bit is “0”. Similarly, “H” or “L” is inputted to the respective other input terminals of the AND circuits 81, 82, and 83, in accordance with the contents of the first bit, second bit, and third bit of the data location description part 35b of the break information 35.

Output signals of the AND circuits 80 to 83 are inputted to the OR circuit 84. A detection result outputted from the compare circuit 30 is inputted to one input terminal of the AND circuit 85, and an output signal of the OR circuit 84 is inputted to the other input terminal. A valid data signal SS is outputted from the AND circuit 85. When the valid data signal SS is “H”, it means that the instruction code required by the CPU 1 exists in the data storage part 35c of the break information 35.

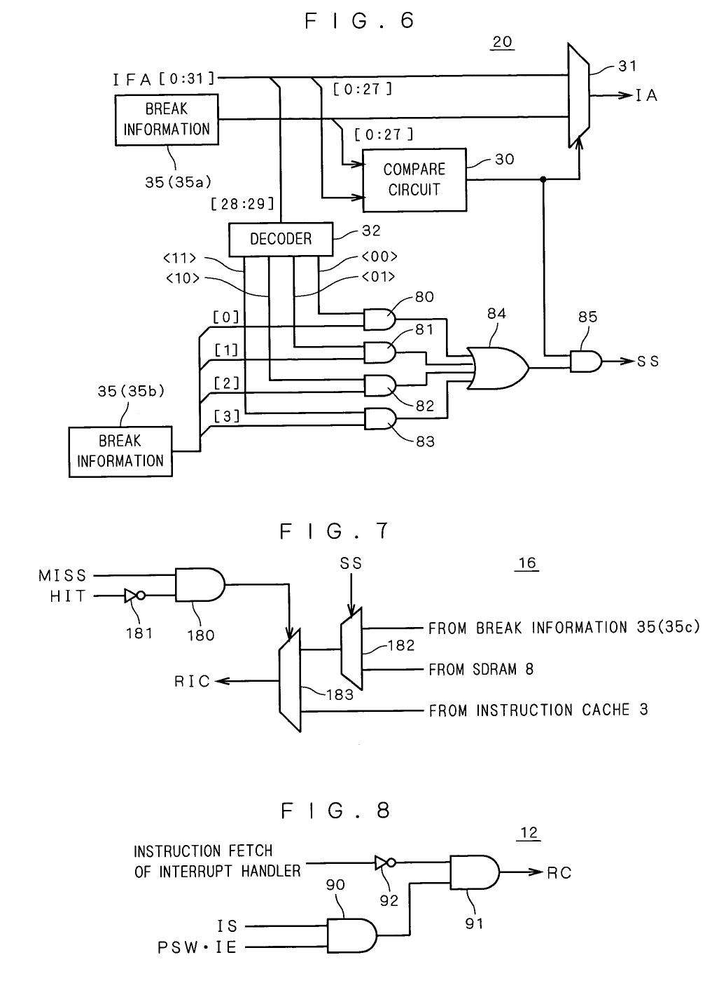

FIG. 7 is a block diagram showing the configuration of the instruction code selector circuit 16 shown in FIG. 3. The instruction code selector circuit 16 comprises an AND circuit 180, an inverter 181, and selector circuits 182 and 183. A miss-hit signal MISS is inputted to one input terminal of the AND circuit 180, and a hit signal HIT inverted by the inverter 181 is inputted to the other input terminal.

An instruction code IC read from the data storage part 35c of the break information 35 is inputted to one input terminal of the selector circuit 182, and an instruction code IC read from the SDRAM 8 is inputted to the other input terminal. When the valid data signal SS is “H”, the selector circuit 182 selects and outputs the instruction code IC read from the data storage part 35c of the break information 35. On the other hand, when it is “L”, the selector circuit 182 selects and outputs the instruction code IC read from the SDRAM 8.

The instruction code IC outputted from the selector circuit 182 is inputted to one input terminal of the selector circuit 183, and an instruction code IC read from the instruction cache 3 is inputted to the other input terminal. When an output signal of the AND circuit 180 is “H” (i.e., in the case of “miss-hit”), the selector circuit 183 selects and outputs the instruction code IC outputted from the selector circuit 182. On the other hand, when it is “L” (i.e., in the case of “hit”), the selector circuit 183 selects and outputs the instruction code IC read from the instruction cache 3.

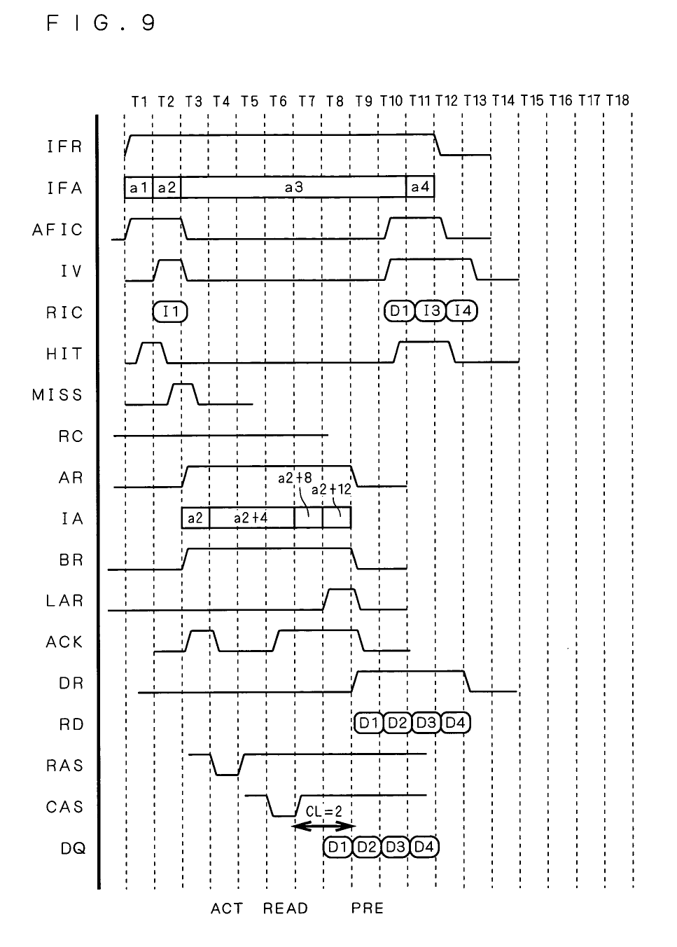

FIG. 8 is a block diagram showing the configuration of the request cancel signal generator circuit 12 shown in FIG. 1. This circuit 12 comprises AND circuits 90 and 91, and an inverter 92. An interrupt signal IS is inputted to one input terminal of the AND circuit 90, and the contents of IE (interrupt enable) bit of a PSW (program status word or processor status word) is inputted to the other input terminal.

A signal, which becomes “H” when an instruction fetch of an interrupt handler is started, is inverted by the inverter 92 and inputted to one input terminal of the AND circuit 91. An output signal of the AND circuit 90 is inputted to the other input terminal. A request cancel signal RC is outputted from the AND circuit 91. The request cancel signal RC becomes “H” only between when the interrupt signal IS is inputted and when the interrupt processing is started.

FIG. 9 is a timing chart showing signal and data transition when no interrupt request IR occurs during burst transfer in the data processor according to the first preferred embodiment. The operation of this data processor when no interrupt request IR occurs during burst transfer will be described below by referring to FIG. 9 and by using FIGS. 1 to 8. The following description is made on the assumption that: one line of the instruction cache 3 is 128 bits; the bus size of the data bus RDB is 32 bits (4 bytes); and cache fill of one line requires four bus accesses. In addition, assume that instruction codes I1, I3, and I4 exist in the instruction cache 3; and that instruction codes D1 to D4 do not exist in the instruction cache 3. Further, assume that CL (CAS latency) is 2.

In term T1, the CPU 1 asserts an instruction fetch request signal IFR and an instruction address signal IFA (address a1) that is related to the instruction code I1. Upon acceptance of an access request to the address a1 (i.e., an instruction fetch request to the instruction code I1), access to the next following address a2 is consecutively required and then to addresses a3 and a4 in the order named. Therefore, an instruction fetch request signal IFR remains “H”. In term T1, the instruction cache 3 accepts an instruction fetch request to the instruction code I1 and inputs a receipt signal AFIC to the CPU 1. Since the instruction code I1 exists in the instruction cache 3, a hit signal HIT becomes “H”.

In term T2, the instruction code I1 corresponding to the address a1 is read from the instruction cache 3 and transferred to the CPU 1. On this occasion, an instruction valid signal IV is set to “H”. The CPU 1 inputs the instruction cache 3 an instruction address IFA (address a2) that is related to an instruction code D1 that succeeds to the instruction code I1. In term T2, the instruction cache 3 accepts an instruction fetch request to the instruction code D1 and inputs a receipt signal AFIC to the CPU 1. Since the instruction code D1 does not exist in the instruction cache 3, a miss-hit signal MISS becomes “H”, and the hit signal HIT becomes “L”.

In term T3, the instruction cache 3 inputs the SDRAM controller 5 an access request signal AR and address signal IA (address a2). In the status of cache-on, the instruction cache 3 requests burst transfer of instruction codes D1 to D4 that correspond to one line, by inputting a burst request signal BR to the SDRAM controller 5. The access request signal AR and burst request signal BR maintain “H” until the SDRAM controller 5 accepts access requests to all the instruction codes D1 to D4 for which burst transfer is required. In term T3, the SDRAM controller 5 accepts an access request to the instruction code D1 and inputs an acknowledge signal ACK to the instruction cache 3.

The CPU 1 inputs the instruction cache 3 an instruction address signal IFA (address a3) related to an instruction code I3 that succeeds to the instruction code D1. The instruction cache 3 will not accept any instruction fetch request to the instruction code I3 (AFIC=“L”) until the instruction cache 3 passes the instruction code D1 to the CPU 1.

In term T4, the SDRAM controller 5 inputs the SDRAM 8 an activation command ACT (RAS=“L”; CAS=“H”; and WE=“H”) in order to activate the SDRAM 8. The instruction cache 3 inputs the SDRAM controller 5 an address signal IA (address a2+4) related to an instruction code D2 that succeeds to the instruction code D1. The SDRAM controller 5 will not accept any access request to the instruction code D2 until the CAS becomes “L” and the next access request is acceptable.

In term T6, the SDRAM controller 5 inputs the SDRAM 8 a read command READ (RAS=“H”; CAS=“L”; and WE=“H”) in order to initiate burst transfer. The SDRAM controller 5 accepts an access request to the instruction code D2 and inputs an acknowledge signal ACK to the instruction cache 3.

In term T7, the instruction cache 3 inputs the SDRAM controller 5 an address signal IA (address a2+8) that is related to an instruction code D3 that succeeds to the instruction code D2. In term t7, the SDRAM controller 5 accepts an access request to the instruction code D3 and inputs an acknowledge signal ACK to the instruction cache 3.

In term T8, the instruction cache 3 inputs the SDRAM controller 5 an address signal IA (address a2+12) related to an instruction code D4 that succeeds to the instruction code D3. In term T8, the SDRAM controller 5 accepts an access request to the instruction code D4 and inputs an acknowledge signal ACK to the instruction cache 3. The instruction cache 3 inputs a last request signal LAR to the SDRAM controller 5. Further, burst transfer is started so that the instruction code D1 is transferred from the SDRAM 8 to the SDRAM controller 5.

In term T9, the instruction code D1 is transferred from the SDRAM controller 5 to the instruction cache 3. On this occasion, a data ready signal DR is set to “H”. Further, the instruction code D2 is transferred from the SDRAM 8 to the SDRAM controller 5. The SDRAM controller 5 inputs the SDRAM 8 a precharge command PRE (RAS=“L”; CAS=“H”; and WE=“L”) in order to precharge the SDRAM 8.

In term T10, the instruction code D1 is transferred from the instruction cache 3 to the CPU 1. On this occasion, an instruction valid signal IV is set to “H”. The instruction cache 3 accepts an instruction address signal IFA about an instruction code I3 and inputs a receipt signal AFIC to the CPU 1. Since the instruction code I3 exists in the instruction cache 3, the hit signal HIT becomes “H”. Further, the instruction code D2 is transferred from the SDRAM controller 5 to the instruction cache 3. On this occasion, the data ready signal DR is set to “H”. Further, the instruction code D3 is transferred from the SDRAM 8 to the SDRAM controller 5.

In term T11, the instruction code I3 is read from the instruction cache 3 and transferred to the CPU 1. On this occasion, the instruction valid signal IV is set to “H”. The CPU 1 inputs the instruction cache 3 an instruction address signal IFA (address a4) related to an instruction code I4 that succeeds to the instruction code I3. The instruction cache 3 accepts the instruction address signal IFA about the instruction code I4 and inputs a receipt signal AFIC to the CPU 1. Since the instruction code I4 exists in the instruction cache 3, the hit signal HIT becomes “H”. Further, the instruction code D3 is transferred from the SDRAM controller 5 to the instruction cache 3. On this occasion, the data ready signal DR is set to “H”. Further, the instruction code D4 is transferred from the SDRAM 8 to the SDRAM controller 5.

In term T12, the instruction code I4 is read from the instruction cache 3 and transferred to the CPU 1. On this occasion, the instruction valid signal IV is set to “H”. Further, the instruction code D4 is transferred from the SDRAM controller 5 to the instruction cache 3. On this occasion, the data ready signal DR is set to “H”. Thus, the instruction code D1 to D4 that correspond to one line are collected, and the instruction cache 3 fills a predetermined line with instruction codes D1 to D4.

If an instruction code that the CPU 1 requests after the instruction code I1 is not the instruction code D1 stored at the top of a memory block of the SDRAM 8, but is an instruction code stored halfway (e.g., an instruction code D3), the instruction cache 3 may output the address signal IA in the order named: addresses a2, a2+4, a2+8, and a2+12, alternatively, in the order named: addresses a2+8, a2+12, a2, and a2+4.

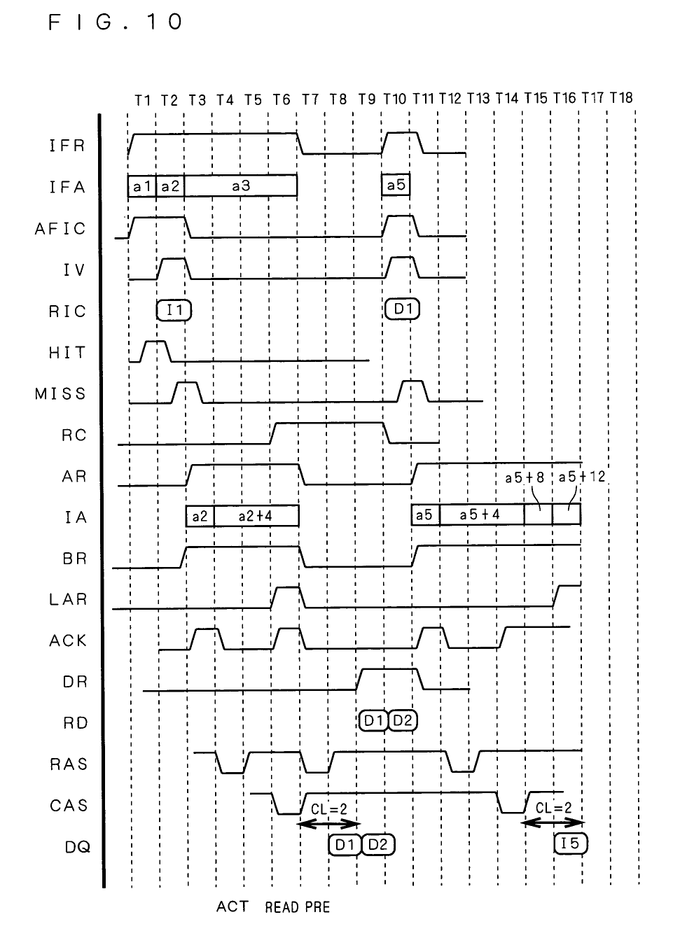

FIG. 10 is a timing chart showing signal and data transition when an interrupt request IR occurs during burst transfer in the data processor of the first preferred embodiment. The operation of this data processor will be described below by referring to FIG. 10 and by using FIGS. 1 to 8. In what follows, assume that an instruction code I5 of an interrupt handler does not exist in the instruction cache 3.

Since the operation flow up to term T5 is the same as that in FIG. 9, a full description thereof is omitted here.

In term T6, the SDRAM controller 5 inputs a read command READ to the SDRAM 8. The SDRAM controller 5 accepts an access request to the instruction code D2 and inputs an acknowledge signal ACK to the instruction cache 3.

An interrupt request IR occurs, and a request cancel signal RC is inputted from the request cancel signal generator circuit 12 to the instruction cache 3. The CPU 1 changes an instruction fetch request signal IFR to “L”, thereby withdrawing any instruction fetch request that is not yet accepted by the instruction cache 3 at this point of time (i.e., instruction fetch requests to addresses a3 and a4 shown in FIG. 9). The instruction cache 3 generates a last request signal LAR and inputs it to the SDRAM controller 5. Further, the instruction cache 3 changes an access request signal AR and burst request signal BR to “L”, thereby withdrawing a burst transfer request to the instruction codes D3 and D4 shown in FIG. 9.

In term T7, the SDRAM controller 5 inputs a precharge command PRE to the SDRAM 8 in order to stop the burst read of SDRAM after clock cycles of the CAS Latency CL pass.

In term T8, burst transfer is started so that the instruction code D1 is transferred from the SDRAM 8 to the SDRAM controller 5.

In term T9, the instruction code D1 is transferred from the SDRAM controller 5 to the instruction cache 3. On this occasion, the data ready signal DR is set to “H”. Further, the instruction code D2 is transferred from the SDRAM 8 to the SDRAM controller 5.

In term T10, the instruction code D1 is transferred from the instruction cache 3 to the CPU 1. On this occasion, the instruction valid signal IV is set to “H”. The instruction cache 3 accepts an instruction address signal IFA (address a5) that is related to the instruction code I5 of the interrupt handler, and also inputs a receipt signal AFIC to the CPU 1. Since the instruction code I5 does not exist in the instruction cache 3, the miss-hit signal MISS becomes “H”. Further, the instruction code D2 is transferred from the SDRAM controller 5 to the instruction cache 3. On this occasion, the data ready signal DR is set to “H”.

In term T11 and the following terms, the respective address signals IA of address a5, as+4, a5+8, and a5+12 are successively inputted from the instruction cache 3 to the SDRAM controller 5, so that the instruction code I5 is read from the SDRAM 8 by burst transfer. The instruction code I5 is transferred to the CPU 1. The CPU 1 executes processing to an interrupt request IR.

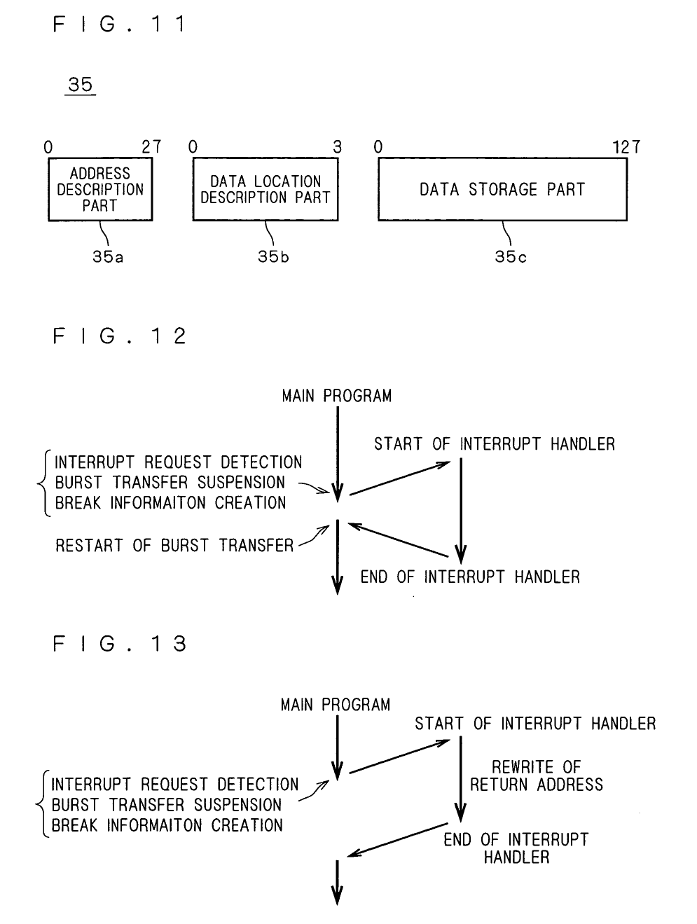

Description will next be given of restart of the suspended burst transfer. FIG. 11 is a diagram showing the break information 35. In the example given in FIG. 10, the burst transfer of the instruction codes D3 and D4 is suspended due to the occurrence of the interrupt request IR. At the time that the burst transfer is suspended, the instruction cache 3 (strictly speaking, the external access request generator circuit 15) creates and holds information about the burst transfer break (break information) 35.

Referring to FIG. 11, the break information 35 has a 28-bit address description part 35a, a 4-bit data location description part 35b, and a 128-bit data storage part 35c. A start address (restart address) used for restarting the suspended burst transfer is described in the address description part 35a. The data storage part 35c stores data that have been transferred from the SDRAM controller 5 to the instruction cache 3 up to when the burst transfer is suspended. Dividing the 128 bits of the data storage part 35c into four 32-bit regions, the data location description part 35b describes in which region a valid data is stored.

In the example given in FIG. 10, [0:27] in address a2+8 of 32 bits is described in the address description part 35a. In the data storage part 35c, the instruction code D1 is stored in [0:31], and the instruction code D2 is stored in [32:63]. No valid data is stored in [64:95] and [96:127] of the data storage part 35c, and they are undefined bits. In the data location description part 35b, there is described [1100], wherein “1” denotes “valid”, and “0” denotes “invalid”.

FIG. 12 is a schematic diagram showing a first processing flow when an interrupt request occurs during execution of main program. The CPU 1 performing the main program processing monitors whether or not any interrupt signal IS is inputted from the ICU 11. When the occurrence of an interrupt request IR is detected during burst transfer to the instruction cache 3, the instruction cache 3 suspends the burst transfer of instruction codes D3 and D4, and also creates break information 35, as described above. A jump to the top address of an interrupt handler takes place after saving information such as PSW and return address. An interrupt processing is started and then completed. Then, a RTE (return from exception/interrupt/trap) instruction is executed thereby to perform a return of the saved PSW and a jump to the return address, thereby returning to the original main program. By referring to the restart address described in the address description part 35a of the break information 35, the instruction cache 3 restarts the burst transfer from the suspended point. That is, the burst transfer of the instruction codes D3 and D4 is restarted. Since the burst transfer is restarted from the suspended point, it is possible to avoid duplicate read and transfer operation with respect to the instruction codes D1 and D2 that have been transferred to the instruction cache 3 before the burst transfer is suspended.

On completion of transfer of the instruction codes D3 and D4 to the instruction cache 3, the instruction cache 3 concatenates (i) the instruction codes D1 and D2 stored in the data storage part 35c of the break information 35 and (ii) the instruction codes D3 and D4 transferred from the SDRAM 8, thereby recording the instruction codes D1 to D4 on a predetermined line.

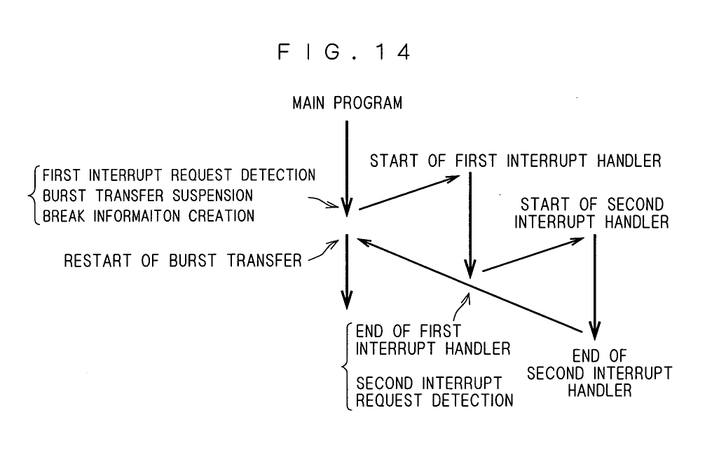

FIG. 13 is a second processing flow when an interrupt request occurs during execution of main program. In FIG. 13, it is assumed that there is no return to the original main program at the completion of the interrupt processing. Since the processing flow to start of interrupt handler is the same as FIG. 12, a full description thereof is omitted here. In the process of the interrupt processing, an interrupt handler rewrites the saved return address to different address from the continuous address of main program. Upon detection of the rewrite of the return address, the instruction cache 3 invalidates the break information 35. That is, the content described in the data location description part 35b is cleared. In this connection, the contents of the address description part 35a and data storage part 35c need not to be cleared, but may be cleared at the same time. On end of the interrupt processing, a RTE instruction is executed and a jump to the top address of the different program takes place, thereby starting the different program processing, without restarting the suspended burst transfer.

In the case of changing to a different program after an interrupt processing is terminated, there seems to be a low possibility that the instruction codes D1 to D4 related to the original program are executed immediately after changing to the different program. In this case, the restart of the suspended burst transfer is not executed in order to avoid wasteful operation caused by the restart of the burst transfer. Therefore, the different program can be started immediately.

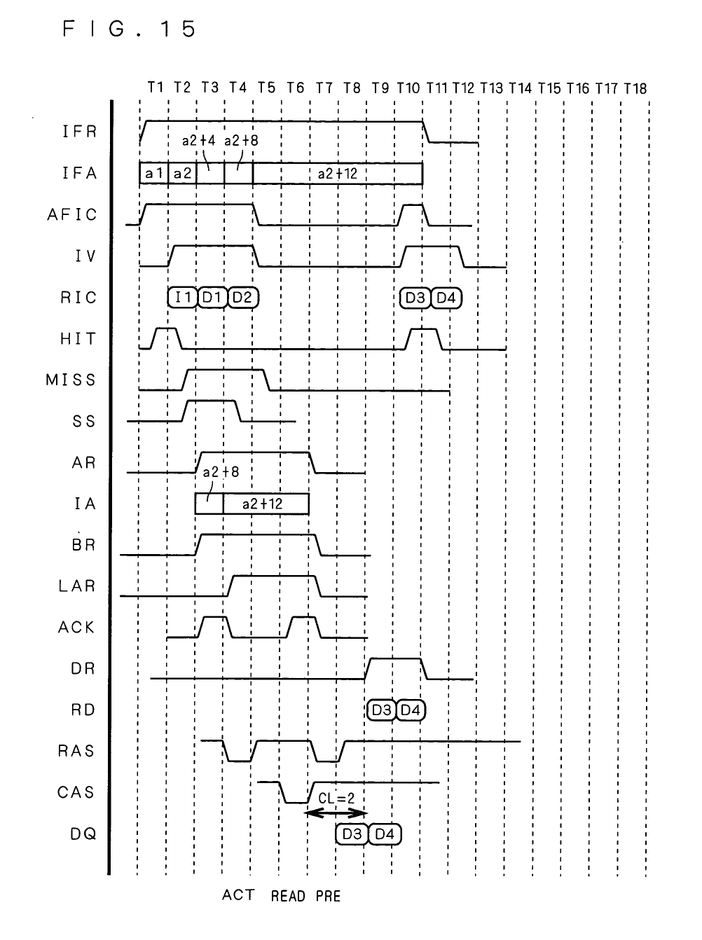

FIG. 14 is a schematic diagram showing a third processing flow when an interrupt request occurs during execution of main program. In FIG. 14, it is assumed that a plurality of interrupt requests occur. In this case, interrupt with higher priority is detected and executed more previously. When an occurrence of a first interrupt request is detected during burst transfer to the instruction cache 3, the instruction cache 3 suspends the burst transfer of the instruction codes D3 and D4, and also creates break information 35, as described above. After saving information such as a PSW and return address, a jump to the top address of a first interrupt handler takes place, thereby starting a first interrupt processing.

Upon detection of an occurrence of a second interrupt request at the termination of the first interrupt processing, a jump to the top address of a second interrupt handler takes place, thereby starting a second interrupt processing. On termination of the second interrupt processing, a RTE instruction is executed to perform a return of the saved PSW and a jump to the return address, thereby returning to the original main program. By referring to the return address described in the address description part 35a of the break information 35, the instruction cache 3 restarts the burst transfer from the suspended point. That is, the burst transfer of the instruction codes D3 and D4 is restarted.

On completion of the transfer of the instruction codes D3 and D4 to the instruction cache 3, the instruction cache 3 concatenates (i) the instruction codes D1 and D2 stored in the data storage part 35c of the break information 35 and (ii) the instruction codes D3 and D4 transferred from the SDRAM 8, thereby recording the instruction codes D1 to D4 on a predetermined line.

After the first interrupt processing, the second interrupt processing is preferentially executed to the restart of the burst transfer, thereby starting the second interrupt processing immediately.

In FIGS. 12 and 14, in the case of returning to the original program at the termination of the interrupt processing, without restarting the burst transfer from the suspended point, burst transfer may be performed again from the beginning with respect to all the regions of the line related to suspention. This requires that, instead of the restart address a2+8, the top address a2 is described in the address description part 35a of the break information 35. The data location description part 35b and data storage part 35c are unnecessary. Further, in FIG. 10, the instruction cache 3 may start an instruction fetch of the instruction code I5 immediately after receiving the request cancel signal RC, without waiting the completion of the burst transfer of the instruction codes D1 and D2.

If it is only desired to stop the burst transfer by interruption, and not intended to restart the burst transfer at the termination of the interrupt processing, it is unnecessary to create and keep the break information 35.

Thus, according to the data processor of the first preferred embodiment, when the interrupt request IR occurs during burst transfer for cache fill, the burst transfer is forced to suspend and the interrupt processing is preferentially executed, without waiting the completion of the burst transfer. Therefore, response characteristics to an interrupt request IR of high urgency is superior to that of conventional data processors.

### Second Preferred Embodiment

In the first preferred embodiment, the instruction cache 3 restarts automatically the suspended burst transfer with the factor of returning to the original program on termination of the interrupt processing, as shown in FIGS. 12 and 14. A second preferred embodiment of the present invention is directed to a method of restarting the burst transfer with a different factor from that in the first preferred embodiment. Like the first preferred embodiment, it is assumed that at the time of transfer of instruction codes D1 and D2 to the instruction cache 3, the burst transfer is suspended and an interrupt processing is started, and that the interrupt processing is already completed.

FIG. 15 is a timing chart showing signal and data transition when the suspended burst transfer is restarted in a data processor according to the second preferred embodiment. Referring to FIG. 15, a CPU 1 requests an instruction code I1 (address a1) and instruction codes D1, D2, D3, and D4 (addresses a2, a2+4, a2+8, and a2+12) that are related to a certain line on which the burst transfer is suspended (hereinafter referred to as a “suspended line”). In the data processor of the second preferred embodiment, the suspended burst transfer is restarted with the factor that the CPU 1 requests any one of a plurality of instruction codes related to the suspended line. This will be concretely described below.

In term T1, the CPU 1 inputs the instruction cache 3 an instruction fetch request signal IFR and an instruction address signal IFA (address a1) related to the instruction code I1. The instruction fetch request signal IFR maintains “H” until the instruction cache 3 accepts all the instruction fetch requests to the instruction codes I1, and D1 to D4, which are required by the CPU 1. In term T1, the instruction cache 3 accepts an instruction fetch request to the instruction code I1 and inputs a receipt signal AFIC to the CPU 1. Since the instruction code I1 exists in the instruction cache 3, a hit signal HIT becomes “H”.

In term T2, the instruction code I1 is read from the instruction cache 3 and transferred to the CPU 1. On this occasion, an instruction valid signal IV is set to “H”. The CPU 1 inputs the instruction cache 3 an instruction address signal IFA (address a2) related to an instruction code D1 that succeeds to the instruction code I1. In term T2, the instruction cache 3 accepts an instruction fetch request to the instruction code D1 and inputs a receipt signal AFIC to the CPU 1.

Since the instruction code D1 is stored in a data storage part 35c of break information 35 and it does not exist in a storage part 17 of the instruction cache 3, a miss-hit signal MISS becomes “H”. On the other hand, as shown in FIG. 6, a compare circuit 30 outputs “H”, and an AND circuit 80 also outputs “H”. As the result, an AND circuit 85 outputs a valid data signal SS of “H”.

In term T3, the instruction code D1 is read from the data storage part 35c of the break information 35 and transferred to the CPU 1. On this occasion, the instruction valid signal IV is set to “H”. The CPU 1 inputs the instruction cache 3 an instruction address signal IFA (address a2+4) related to an instruction code D2 that succeeds to the instruction code D1. In term T3, the instruction cache 3 accepts an instruction fetch request to the instruction code D2 and inputs a receipt signal AFIC to the CPU 1.

Since the instruction code D2 does not exist in the storage part 17 of the instruction cache 3, the miss-hit signal MISS becomes “H”. On the other hand, as shown in FIG. 6, the compare circuit 30 outputs “H”, and the AND circuit 81 also outputs “H”. As the result, the AND circuit 85 outputs a valid data signal SS of “H”.

Further, the instruction cache 3 inputs a SDRAM controller 5 an access request signal AR and burst request signal BR. Referring to FIG. 6, since the compare circuit 30 outputs a detection result of “H”, a selector circuit 31 selects a restart address (address a2+8) of the break information 35 and outputs it as address signal IA. In term T3, the SDRAM controller 5 accepts this access request, namely an access request to an instruction code D3, and inputs an acknowledge signal ACK to the instruction cache 3.

In term T4, the instruction code D2 is read from the data storage part 35c of the break information 35 and transferred to the CPU 1. On this occasion, the instruction valid signal IV is set to “H”. The CPU 1 inputs the instruction cache 3 an instruction address signal IFA (address a2+8) related to the instruction code D3 that succeeds to the instruction code D2. In term T4, the instruction cache 3 accepts an instruction fetch request to the instruction code D3 and inputs a receipt signal AFIC to the CPU 1.

Since the instruction code D3 does not exist in the storage part 17 of the instruction cache 3, the miss-hit signal MISS becomes “H”. Referring to FIG. 6, the AND circuit 82 outputs “L”, and therefore, the AND circuit 85 outputs a valid data signal SS of “L”.

The SDRAM controller 5 inputs an activation command ACT to a SDRAM 8. The instruction cache 3 inputs the SDRAM controller 5 an address signal IA (address a2+8) related to an instruction code D4 that succeeds to the instruction code D3. The SDRAM controller 5 will not accept any access request to the instruction code D4 until the next access request is acceptable. Further, the instruction cache 3 inputs a last request signal LAR to the SDRAM controller 5.

In term T5, the CPU 1 inputs the instruction cache 3 an instruction address signal IFA (address a2+12) related to an instruction code D4 that succeeds to the instruction code D3. The instruction cache 3 will not accept any instruction fetch request to the instruction code D4 until the instruction cache 3 passes the instruction code D3 to the CPU 1.

In term T6, the SDRAM controller 5 inputs a read command READ to the SDRAM 8. The SDRAM controller 5 accepts an access request to the instruction code D4 and inputs an acknowledge signal ACK to the instruction cache 3.

In term T7, the SDRAM controller 5 inputs a precharge command PRE to the SDRAM 8.

In term T8, burst transfer is started so that the instruction code D3 is transferred from the SDRAM 8 to the SDRAM controller 5.

In term T9, the instruction code D3 is transferred from the SDRAM controller 5 to the instruction cache 3. On this occasion, a data ready signal DR is set to “H”. Further, the instruction code D4 is transferred from the SDRAM 8 to the SDRAM controller 5.

In term T10, the instruction code D4 is transferred from the SDRAM controller 5 to the instruction cache 3. On this occasion, the data ready signal DR is set to “H”. Thus, the instruction codes D1 to D4 that correspond to one line are collected, and the instruction cache 3 records the instruction codes D1 to D4 on a predetermined line.

Further, the instruction code D3 is transferred from the instruction cache 3 to the CPU 1. On this occasion, the instruction valid signal IV is set to “H”. The instruction cache 3 also accepts an instruction address signal IFA related to the instruction code D4 and inputs a receipt signal AFIC to the CPU 1. Since the instruction code D4 exists in the instruction cache 3, the hit signal HIT becomes “H”.

In term T11, the instruction code D4 is read from the instruction cache 3 and transferred to the CPU 1. On this occasion, the instruction valid signal IV is set to “H”.

Thus, according to the data processor of the second preferred embodiment, the burst transfer of the suspended instruction codes D3 and D4 is restarted with the factor that the CPU 1 requests one of the instruction codes D1 to D4 related to the suspended line. Therefore, even in the case of not returning to the original program immediately after the interrupt processing is terminated, the burst transfer can be restarted at the next succeeding access to the suspended line.

### Third Preferred Embodiment

A third preferred embodiment of the present invention is directed to a method of restarting burst transfer with a different factor from that in the first or second preferred embodiment. In a data processor according to the third preferred embodiment, the suspended burst transfer is restarted with the factor that a RTE instruction is detected during execution of interrupt processing. This will be described below taking as example the case that a CPU 1 performs pipeline processing.

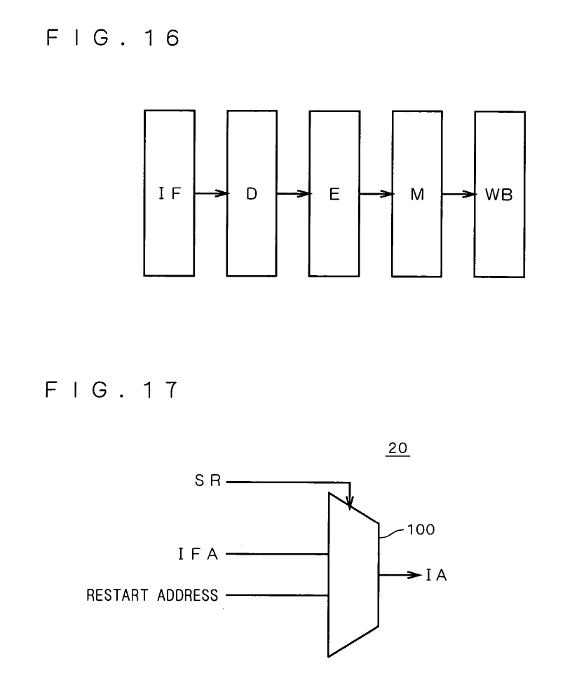

A description of pipeline processing will be presented prior to the description of restart of burst transfer. FIG. 16 is a schematic diagram showing an example of pipeline processing. This pipeline processing can be implemented by consecutively performing the following stages in the order named: instruction fetch stage IF, decode stage D, instruction execution stage E, memory access stage M, and write back stage WB.

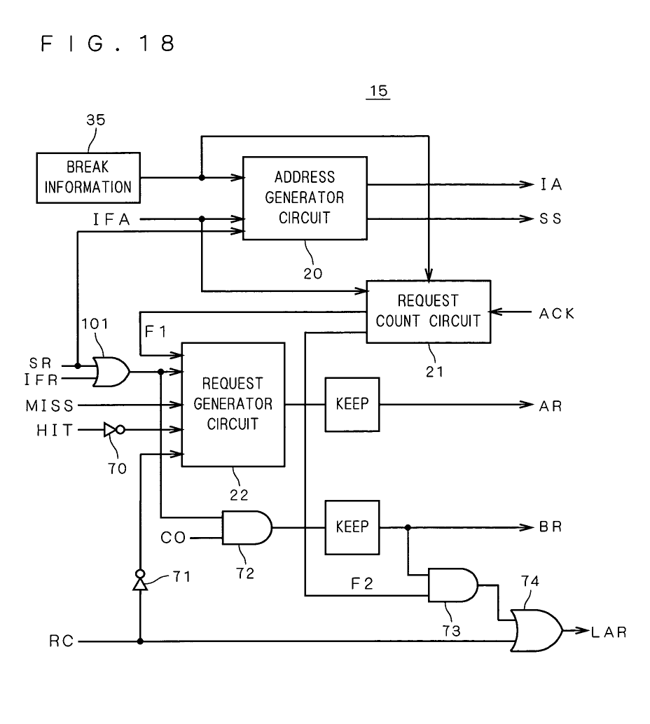

FIG. 17 is a block diagram showing the configuration of an address generator circuit 20 of the third preferred embodiment. This address generator circuit 20 has a selector circuit 100. An instruction address signal IFA and a restart address stored in an address description part 35a of break information 35 are inputted to the selector circuit 100. A RTE detection signal SR is also inputted to the selector circuit 100. The RTE detection signal SR becomes “H” when a RTE instruction is decoded on the decode stage D in the pipeline processing. When the RTE detection signal SR is “H”, the selector circuit 100 selects the restart address. On the other hand, when it is “L”, the selector circuit 100 selects the instruction address signal IFA and outputs it as an address signal IA. Similarly to FIG. 6, the address generator circuit 20 of the third preferred embodiment has a configuration for generating a valid data signal SS, although this is omitted in FIG. 17.

FIG. 18 is a block diagram showing the configuration of an external access request generator circuit 15 of the third preferred embodiment. This external access request generator circuit 15 further comprises an OR circuit 101, in addition to the configuration shown in FIG. 4. A RTE detection signal SR is inputted to one input terminal of the OR circuit 101, and an instruction fetch request signal IFR is inputted to the other input terminal. An output signal of the OR circuit 101 is inputted to a request generator circuit 22 and AND circuit 72. The request generator circuit 22 will not output any access request signal AR when “0000” is described in a data location description part 35b of break information 35, even if the RTE detection signal SR is “H” and “H” is inputted from the OR circuit 101.

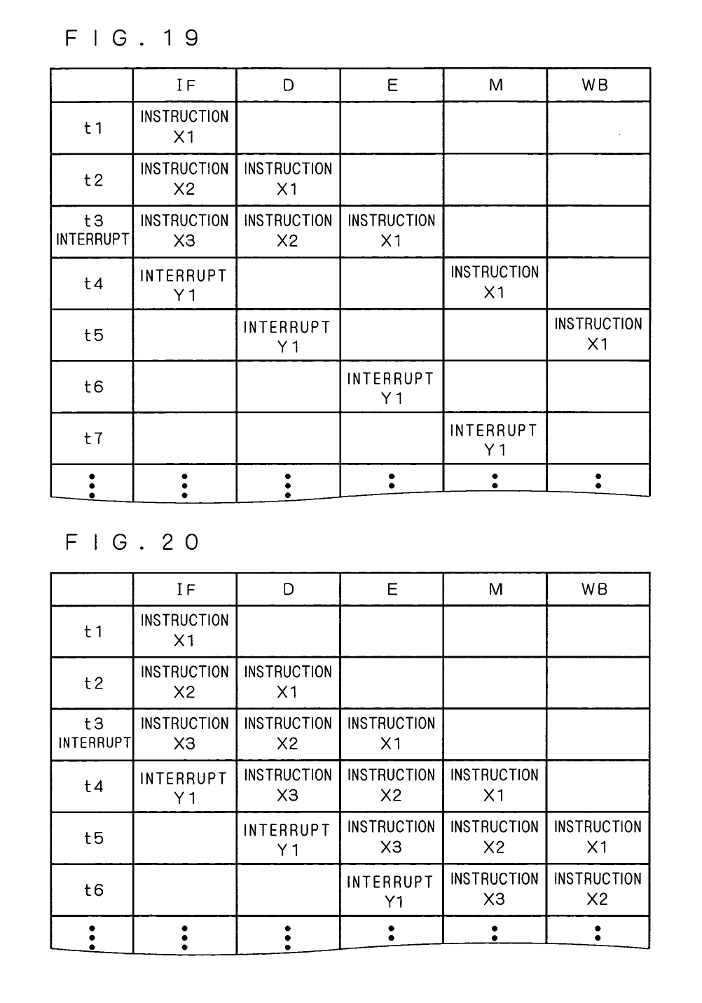

FIG. 19 is a diagram showing a situation where pipeline processing is executed. It is assumed that instructions X1 to X3 shown in FIG. 19 and instruction X4 not shown in FIG. 19 are to be stored on one line of an instruction cache 3. In term t1, instruction X1 is processed at the instruction fetch stage IF. In term t2, instruction X1 is processed at the decode stage D, and instruction X2 is processed at the instruction fetch stage IF. In term t3, instruction X1 is process on an instruction execution stage E, and instruction X2 is processed at the decode stage D, and instruction X3 is processed at the instruction fetch stage IF. An interrupt (interrupt instruction Y1) occurs in term t3.

In term t4, the interrupt instruction Y1 is preferentially processed prior to instruction X4 that succeeds to instruction X3, at the instruction fetch stage IF. On this occasion, the top address of instruction X4 is described in the address description part 35a of the break information 35. Note that instruction X4 is to be processed after term t5 at the instruction fetch stage IF. At the time that data corresponding to one line are collected, instructions X1 to X4 are recorded on the instruction cache 3.

Further in term t4, at the decode stage D and instruction execution stage E, the processing to instructions (instructions X2 and X3 in this instance), which are not yet processed at the instruction execution stage E when the interrupt instruction Y1 occurs (i.e., in term t3), are held preparatory to the processing to the interrupt instruction Y1. Relating to the instruction execution stage E, the top address of instruction X2 is set as a return address, and saved together with a PSW. On the other hand, the succeeding processing will be performed to an instruction to which the processing at the instruction execution stage E is already executed at the occurrence of the interrupt instruction Y1. In this instance, instruction X1 is processed at the memory access stage M.

The interrupt instruction Y1 is processed at the decode stage D in term t5, and then processed at the instruction execution stage E in term t6. On termination of the interrupt processing, the processing is restarted from the instruction fetch stage IF with respect to instruction X2 of which address has been held as the return address. This way, the interrupt instruction Y1 is processed preferentially to instructions X2 to X4, which are not yet processed at the instruction execution stage E at the occurrence of the interrupt instruction Y1. Thereby, the interrupt processing of high urgency can be started immediately. For example, even if the execution of instructions X2 and X3 requires a long period of time, the execution of the interrupt instruction Y1 is not started after the executions of instructions X2 and X3 are completed. Therefore, the execution of the interrupt instruction Y1 can be started immediately.

If a comparison of the preference of the occurred interrupt instruction Y1 with a preset predetermined preference indicates that the former is below the latter, the following processing may be performed. Preference setting and comparison will be described in detail in a fifth preferred embodiment of the present invention.

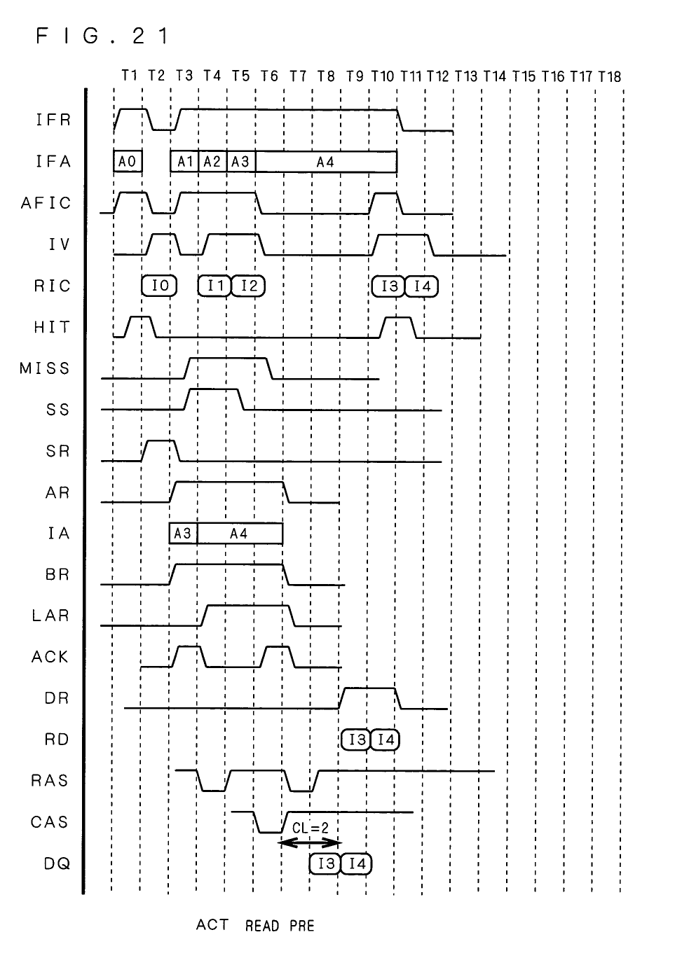

FIG. 20 is a diagram showing a situation whether pipeline processing is executed. In term t3, there occurs an interrupt instruction Y1 of which preference is below a predetermined preference. At the instruction execution stage E, the interrupt instruction Y1 is processed after the processing to instructions X1 to X3 that are already fetched before the interrupt instruction Y1 is fetched. In this case, the top address of instruction X4 is set as a return address, and saved together with a PSW. This is true for the decode stage D, memory access stage M, and write back stage WB. If the urgency of the occurred interrupt request is not so high, by performing processing to instructions X1 to X3 prior to the interrupt instruction Y1, the processing can be progressed without disturbing the pipeline, and the penalty caused by the interrupt processing can be eliminated. That is, it is determined whether the pipeline should be cancelled depending on the interrupt processing preference. As the result, when the interrupt processing has a high urgency, the pipeline can be cancelled to perform the interrupt processing immediately. On the other hand, when the interrupt processing is not of high urgency, the penalty caused by the interrupt processing can be reduced without canceling the pipeline. This enables to increase processing capabilities as a whole.

This way, the CPU 1 implements the pipeline processing. In this pipeline processing, the RTE instruction is processed at the decode stage D prior to the instruction execution stage E. It is therefore possible to detect the RTE instruction at the decode stage D before the RTE instruction is actually processed at the instruction execution stage E. Based on this, the data processor of the third preferred embodiment restarts the suspended burst transfer, even during execution of an interrupt processing, with the factor that an instruction for terminating the interrupt processing (i.e., RTE instruction) is detected.

FIG. 21 is a timing chart showing signal and data transition when the suspended burst transfer is restarted in the data processor of the third preferred embodiment. It is assumed that the burst transfer is suspended at the completion of the transfer of instruction codes I1 and I2 among instruction codes I1 to I4 (addresses A1 to A4) to be stored on one line of the instruction cache 3. In FIG. 21, an instruction code I0 (address A0) is the instruction code of an interrupt handler.

In term T2, a RTE detection signal SR becomes “H” based on the fact that a RTE instruction is detected at the decode stage D.

In term T3, the CPU 1 inputs the instruction cache 3 an instruction fetch request signal IFR and an instruction address signal IFA (address A1) related to an instruction code I1. In term T3, the instruction cache 3 accepts an instruction fetch request to the instruction code I1 and inputs a receipt signal AFIC to the CPU 1. Since the instruction code I1 is stored in a data storage part 35c of break information 35, a miss-hit signal MISS and a valid data signal SS become “H”.

The instruction cache 3 also inputs an access request signal AR and burst request signal BR to the SDRAM controller 5. Referring to FIG. 6, the selector circuit 31 selects a restart address (address A3) of the break information 35 and outputs it as an address signal IA. In term T3, the SDRAM controller 5 accepts this access request, namely an access request to the instruction code I3, and inputs an acknowledge signal ACK to the instruction cache 3.

In term T4, the instruction code I1 is read from the data storage part 35c of the break information 35 and transferred to the CPU 1. On this occasion, an instruction valid signal IV is set to “H”. Further, the CPU 1 inputs the instruction cache 3 an instruction address signal IFA (address A2) related to an instruction code I2 that succeeds to the instruction code I1. In term T4, the instruction cache 3 accepts an instruction fetch request to the instruction code I2 and inputs a receipt signal AFIC to the CPU 1. Since the instruction code I2 is stored in the data storage part 35c of the break information 35, the miss-hit signal MISS and valid data signal SS become “H”.

The SDRAM controller 5 inputs an activation command ACT to the SDRAM 8. The instruction cache 3 inputs the SDRAM controller 5 an address signal IA (address A4) related to an instruction code I4 that succeeds to the instruction code I3. The SDRAM controller 5 will not accept any access request to the instruction code I4 until the next access request is acceptable. The instruction cache 3 also inputs a last request signal LAR to the SDRAM controller 5.

In term T5, the instruction code I2 is read from the data storage part 35c of the break information 35 and transferred to the CPU 1. On this occasion, the instruction valid signal IV is set to “H”. The CPU 1 inputs the instruction cache 3 an instruction address signal IFA (address A3) related to an instruction code I3 that succeeds to the instruction code I2. In term T5, the instruction cache 3 accepts an instruction fetch request to the instruction code I3 and inputs a receipt signal AFIC to the CPU 1. Since the instruction code I3 does not exist in the instruction cached 3, the miss-hit signal MISS becomes “H”.

In term T6, the CPU 1 inputs the instruction cache 3 an instruction address signal IFA (address A4) related to an instruction code I4 that succeeds to the instruction code I3. The instruction cache 3 will not accept any instruction fetch request to the instruction code I4 until the instruction cache 3 passes the instruction code I3 to the CPU 1.

The SDRAM controller 5 inputs a read command READ to the SDRAM 8. The SDRAM controller 5 accepts an access request to the instruction code I4 and inputs an acknowledge signal ACK to the instruction cache 3.

In term T7, the SDRAM controller 5 inputs a precharge command PRE to the SDRAM 8.

In term T8, burst transfer is started so that the instruction code I3 is transferred from the SDRAM 8 to the SDRAM controller 5.

In term T9, the instruction code I3 is transferred from the SDRAM controller 5 to the instruction cache 3. On this occasion, a data ready signal DR is set to “H”. Further, the instruction code I4 is transferred from the SDRAM 8 to the SDRAM controller 5.

In term T10, the instruction code I4 is transferred from the SDRAM controller 5 to the instruction cache 3. On this occasion, the data ready signal DR is set to “H”. Thus, instruction codes I1 to I4 that correspond to one line are collected, and the instruction cache 3 records the instruction codes I1 to I4 on a predetermined line.

Further, the instruction code I3 is transferred from the instruction cache 3 to the CPU 1. On this occasion, the instruction valid signal IV is set to “H”. The instruction cache 3 also accepts an instruction address signal IFA related to the instruction code I4 and inputs a receipt signal AFIC to the CPU 1. Since the instruction code I4 exists in the instruction cache 3, a hit signal HIT becomes “H”.

In term T11, the instruction code I4 is read from the instruction cache 3 and transferred to the CPU 1. On this occasion, the instruction valid signal IV is set to “H”.

Thus, according to the data processor of the third preferred embodiment, the burst transfer of the suspended instruction codes I3 and I4 is restarted with the factor that the RTE instruction is detected. Therefore, the burst transfer can be restarted even when the interrupt processing is still executed. Compared to the case of restarting at the completion of the interrupt processing, the burst transfer can be restarted more immediately.

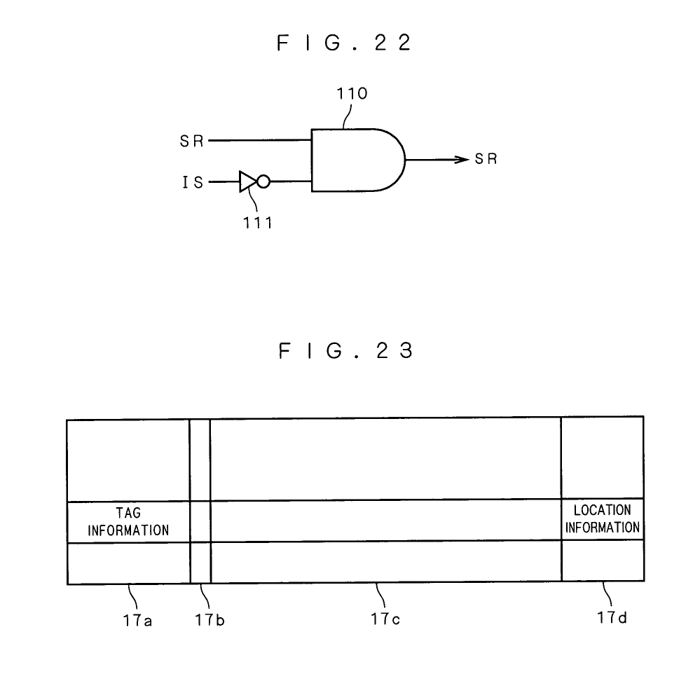

In the case that a plurality of interrupt requests occur as shown in FIG. 14, the following configuration can be employed. FIG. 22 is a block diagram showing the configuration of a circuit for generating a RTE detection signal SR. A RTE detection signal SR is inputted to one input terminal of an AND circuit 110, and an interrupt signal IS inverted by an inverter 111 is inputted to the other input terminal. With this configuration, the AND circuit 110 outputs the RTE detection signal SR when the interrupt signal IS is “L”, and will not output the RTE detection signal SR when the interrupt signal IS is “H”. The RTE detection signal SR outputted from the AND circuit 110 is inputted to an OR circuit 101 shown in FIG. 18.

Referring to FIG. 14, even when the RTE instruction related to a first interrupt processing is detected, a second interrupt request occurs at the same time. Therefore, no RTE detection signal SR is outputted from an AND circuit 22 shown in FIG. 22. As the result, without restarting the suspended burst transfer, a jump to the top address of a second interrupt handler takes place, thereby starting the second interrupt processing.

When the RTE instruction related to the second interrupt processing is detected, no interrupt request occurs at that point. Therefore, the RTE detection signal SR is outputted from the AND circuit 22 shown in FIG. 22, and the suspended burst transfer is restarted. Then, a RTE instruction related to the second interrupt processing is executed, thereby returning to the main program.

### Fourth Preferred Embodiment

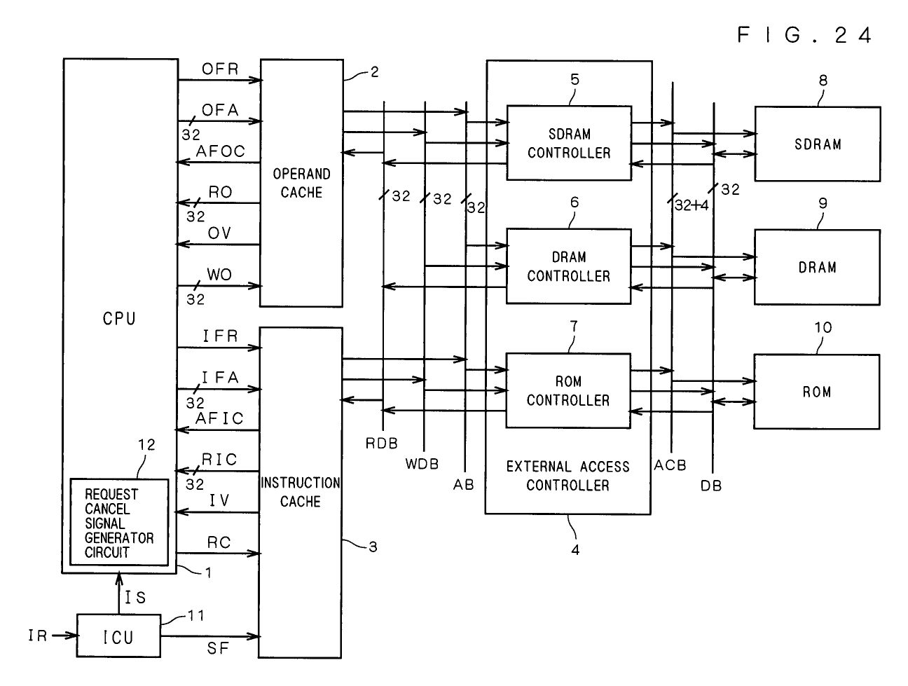

FIG. 23 is a schematic diagram showing the configuration of a storage part 17 of an instruction cache 3 according to a fourth preferred embodiment of the present invention. In the foregoing first to third preferred embodiments, the instruction cache 3 holds, in the external access request generator circuit 15, the break information 35 that is related only to the suspended line. On the other hand, in a data processor of the fourth preferred embodiment, break information 35 is not held by an external access request generator circuit 15, but information equivalent to the break information 35 is stored in a storage part 17 of the instruction cache 3.

The storage part 17 is divided into a plurality of lines, each having a tag part 17a, valid bit 17b, data part 17c, and data location description part 17d. Tag information of recorded data is described in the tag part 17a. In each line, a restart address is generated from the tag part 17a and the data location description part 17d when each line is the suspended line.

The data part 17c stores recorded data. The data part 17c also stores data relating to the suspended line, which are already transferred to the instruction cache 3 before suspending the burst transfer.

Like the data location description part 35b of the break information 35, dividing 128 bits of the data part 17c into four 32-bit regions, the data location description part 17d describes in which region a valid data is stored. Data of “1111” is described in the data location description part 17d that is related to lines other than the suspended line.

In the case of applying the storage part 17 to the data processors according to the first to third preferred embodiments, the instruction cache 3 restarts the burst transfer from the suspended point indicated by the restart address generated from the parts 17a and 17d of the storage part 17.

As stated above, the same operation as in the first to third preferred embodiments is attainable and the same effect is obtainable by storing information equivalent to the break information 35 in the storage part 17 of the instruction cache 3, without holding the break information 35 on the external access request generator circuit 15.

The invention according to the fourth preferred embodiment is also applicable to a data processor according to a fifth or sixth preferred embodiment to be described below.

### Fifth Preferred Embodiment

FIG. 24 is a block diagram showing the configuration of a data processor according to a fifth preferred embodiment of the present invention. An interrupt permission signal SF is inputted to an instruction cache 3 from an ICU 11.

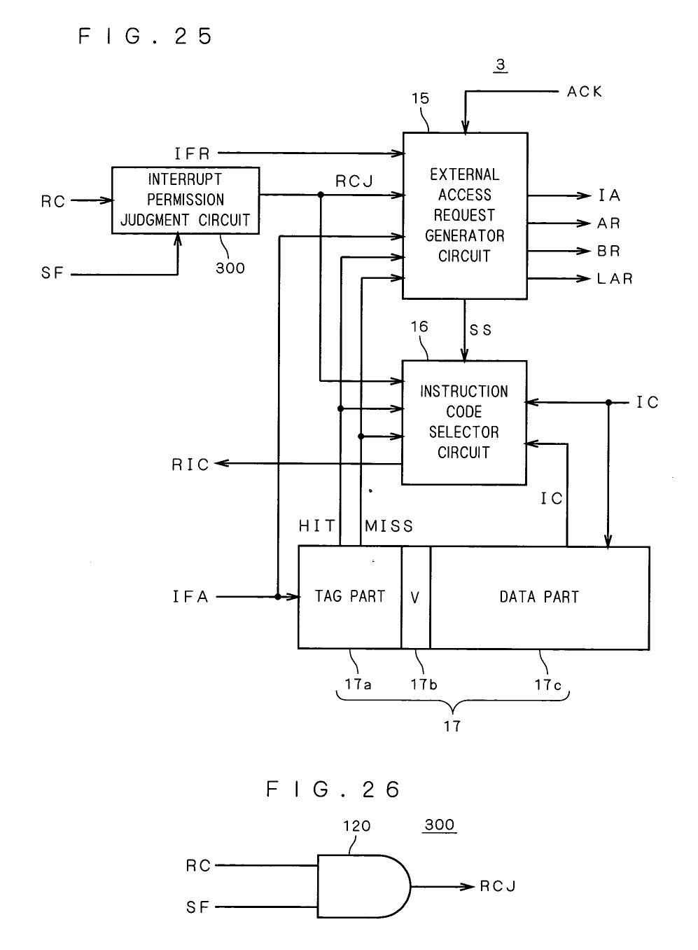

FIG. 25 is a block diagram showing the configuration of the instruction cache 3 of the fifth preferred embodiment. An interrupt permission signal SF and a request cancel signal RC are inputted to an interrupt permission judgment circuit 300. The request cancel signal RCJ is outputted from the interrupt permission judgment circuit 300 and inputted to an external access request generator circuit 15.

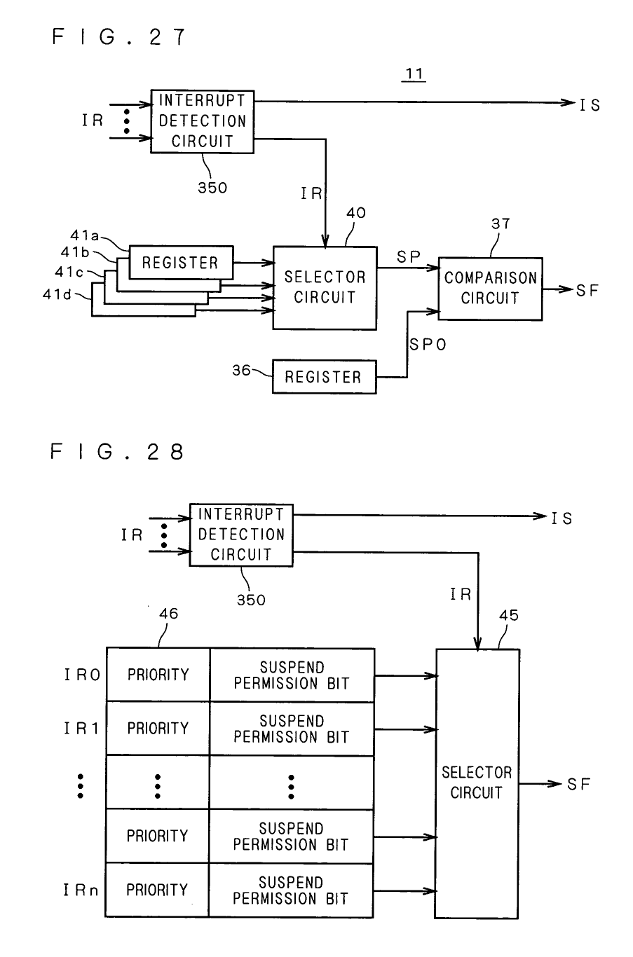

FIG. 26 is a block diagram showing the configuration of the interrupt permission judgment circuit 300. A request cancel signal RC is inputted to one input terminal of an AND circuit 120, and an interrupt permission signal SF is inputted to the other input terminal. With this configuration, the AND circuit 120 outputs the request cancel signal RCJ when the interrupt permission signal SF is “H”, and will not output the request cancel signal RCJ when the signal SF is “L”.

FIG. 27 is a block diagram showing a first configuration of an ICU 11 according to the fifth preferred embodiment. This ICU 11 comprises an interrupt detection circuit 350, registers 36 and 41a to 41d, comparison circuit 37, and selector circuit 40. At least one interrupt request IR is inputted to the interrupt detection circuit 350. The circuit 350 detects an occurrence of interrupt request IR by edge designation or level designation, and outputs an interrupt signal IS and interrupt request IR.

The interrupt request IR from the interrupt detection circuit 350 is inputted to the selector circuit 40. The priority of interrupt is preset to the registers 41a to 41d, in accordance with various interrupt factors. By referring to the contents of the registers 41a to 41d, the selector circuit 40 finds priority SP related to an interrupt request IR inputted from the interrupt detection circuit 350, and inputs the priority SP to one input terminal of the comparison circuit 37. When a plurality of interrupt requests IR are inputted from the interrupt detection circuit 350, the selector circuit 40 selects the interrupt request IR having the highest priority of interrupt from these interrupt requests IR, by referring to the contents of the registers 41a to 41d. Then, the selector circuit 40 inputs priority SP of the selected interrupt request IR to one input terminal of the comparison circuit 37.

A predetermined priority SP0 that is the same as the priority to the registers 41a to 41d is preset to the register 36. Priority SP0 is inputted to the other input terminal of the comparison circuit 37. The comparison circuit 37 compares priority SP and priority SP0. When priority SP is higher than priority SP0, the comparison circuit 37 outputs an interrupt permission signal SF of “H”. When priority SP is lower than or equal to priority SP0, the circuit 37 will not output any interrupt permission signal SF.

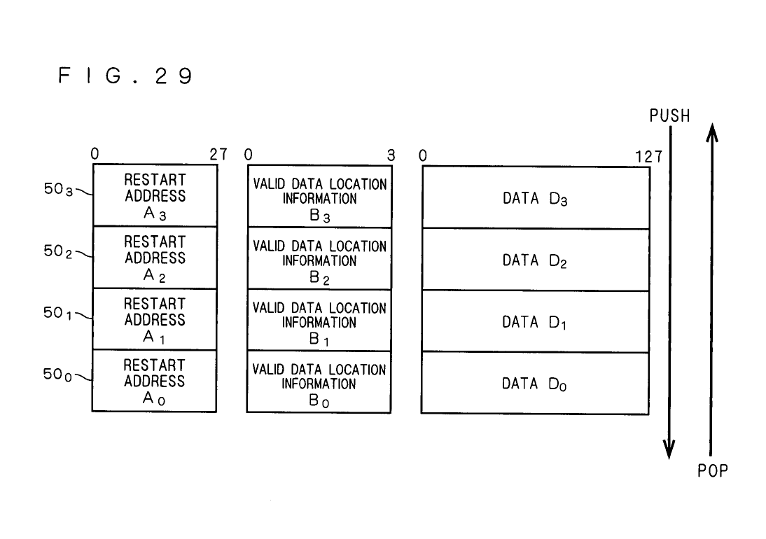

FIG. 28 is a block diagram showing a second configuration of the ICU 11 of the fifth preferred embodiment. This ICU 11 comprises an interrupt detection circuit 350, register 46, and selector circuit 45. An interrupt request IR is inputted to the interrupt detection circuit 350. The circuit 350 outputs an interrupt signal IS and interrupt request IR.

In the register 46, suspend permission bit of “H” or “L” is preset to various interrupt requests IR0 to IRn, respectively. An interrupt request IR is inputted from the interrupt detection circuit 350 to the selector circuit 45. The circuit 45 reads from the register 46 an interrupt permission bit related to the interrupt request IR inputted from the interrupt detection circuit 350, and outputs its bit content (“H” or “L”) as an interrupt permission signal SF.

Thus, according to the data processor of the fifth preferred embodiment, burst transfer can be suspended only when there occurs an interrupt request IR requiring a prompt response. Therefore, when there occurs an interrupt request IR requiring no prompt response, it is avoidable that burst transfer is suspended and a main program processing is further slowed than necessary.

### Sixth Preferred Embodiment

In the foregoing first to fifth preferred embodiments, burst transfer is suspended when an interrupt instruction is detected. Based on the same concept, burst transfer can be suspended when a branch instruction is detected.

Consider now a situation where in the process of executing a first program, burst transfer (for the sake of convenience, hereinafter referred to as a “first burst transfer”) is performed from an SDRAM 8 via an SDRAM controller 5 to an instruction cache 3. When a CPU 1 detects a branch instruction (for the sake of convenience, hereinafter referred to as a “first branch instruction”) during the first burst transfer, a data processor suspends the first burst transfer and starts the execution of a second program as a branch target. On this occasion, break information 35 is created. Upon completion of the second program execution, the data processor restarts the first burst transfer from the suspended point, based on the contents of the break information 35.

In an alternative, break information 35 may be created and held, for example, only when there is a high possibility of returning to the first program after the second program execution is terminated, wherein the first program is a main program and the second program is a sub-routine of the main program. This is to eliminate the following waste. That is, if not returning to the first program at the termination of the second program execution, it is wasteful to restart the suspended first burst transfer and create and hold the break information 35.

When other branch instruction (hereinafter referred to as a “second branch instruction”) is detected by nesting during burst transfer (hereinafter referred to as a “second burst transfer”) in the process of executing the second program, the following processing is performed. Specifically, the data processor suspends the second burst transfer and starts the execution of a third program as a branch target. On this occasion, new break information 35 is created. Upon completion of the third program execution, the data processor restarts the second burst transfer from the suspended point, based on the new break information 35.

FIG. 29 is a schematic diagram showing a stack region 50 for holding a plurality of break information to be created sequentially. Every time new break information 35 is created by detection of a branch instruction, the created break information 35 is pushed down on the uppermost stage 50₃ of the stack region 50. Every time of returning to the original program at the termination of the execution of a branch target program, the break information 35 on the uppermost stage 50₃ is popped up from the stack region 50. In the example given in FIG. 29, the stack region 50 is formed by four stages of the lowermost stage 50₀ to the uppermost stage 50₃, so as to hold four types of break information 35.

Thus, according to the data processor of the sixth preferred embodiment, when the branch instruction is detected during burst transfer, the burst transfer is forced to suspended and the branch target program is preferentially executed, without starting the branch target program execution at the completion of the burst transfer. Therefore, the branch target program can be started immediately.

While the invention has been shown and described in detail, the foregoing description is in all aspects illustrative and not restrictive. It is therefore understood that numerous modifications and variations can be devised without departing from the scope of the invention.

What is claimed is:

1. A data processor comprising:
a processor;
a first storage device; and
a second storage device connected between said processor and said first storage device,
wherein when a predetermined data required by said processor does not exist in said second storage device, a plurality of data corresponding to one line of said second storage device, including said predetermined data, are read from said first storage device and transferred to a certain line of said second storage device by burst transfer,
whereby when an interrupt request occurs during said burst transfer, said burst transfer is suspended and an interrupt processing is started.

2. The data processor according to claim 1 wherein
said burst transfer suspended is restarted after the completion of said interrupt processing.

3. The data processor according to claim 2 wherein
said burst transfer suspended is restarted only when returning to the original program in which said burst transfer is suspended.

4. The data processor according to claim 2 wherein
when a plurality of interrupt requests occur, a plurality of interrupt processing are executed sequentially and, after the completion of the last interrupt processing, said burst transfer suspended is restarted.

5. The data processor according to claim 2, further comprising:
an information register for keeping information about a point at which said burst transfer is suspended, wherein
among said plurality of data, only data not read from said first storage device due to suspension of said burst transfer are read from said first storage device and transferred based on said information when said burst transfer is restarted.

6. The data processor according to claim 2 wherein
said second storage device has a plurality of lines,
each line having information about a point at which said burst transfer is suspended, and
among said plurality of data, only data not read from said first storage device due to suspension of said burst transfer are read from said first storage device and transferred based on said information in said burst transfer restarted.

7. The data processor according to claim 1 wherein
said burst transfer suspended is restarted when a certain line related to suspension of said burst transfer is accessed by said processor after said interrupt processing is completed.

8. The data processor according to claim 7, further comprising:
an information register for keeping information about a point at which said burst transfer is suspended, wherein
among said plurality of data, only data not read from said first storage device due to suspension of said burst transfer are read from said first storage device and transferred based on said information in said burst transfer restarted.

9. The data processor according to claim 7 wherein
said second storage device has a plurality of lines,
each line having information about a point at which said burst transfer is suspended, and
among said plurality of data, only data not read from said first storage device due to suspension of said burst transfer are read from said first storage device and transferred based on said information in said burst transfer restarted.

10. The data processor according to claim 1 wherein
said burst transfer suspended is restarted when an instruction for terminating said interrupt processing is detected during execution of said interrupt processing.

11. The data processor according to claim 10 wherein
when a plurality of interrupt requests occur, a plurality of interrupt processing are executed sequentially and, when an instruction for terminating the last interrupt processing is detected, said burst transfer is restarted.

12. The data processor according to claim 10, further comprising:
an information register for keeping information about a point at which said burst transfer is suspended, wherein
among said plurality of data, only data not read from said first storage device due to suspension of said burst transfer are read from said first storage device and transferred based on said information in said burst transfer restarted.

13. The data processor according to claim 10 wherein
said second storage device has a plurality of lines,
each line having information about a point at which said burst transfer is suspended, and
among said plurality of data, only data not read from said first storage device due to suspension of said burst transfer are read from said first storage device and transferred based on said information in said burst transfer restarted.

14. The data processor according to claim 1, further comprising:
a register to which a predetermined priority related to an interrupt factor is set, and
a judgment unit comparing a priority of said interrupt request with said predetermined priority set in said register, and judging, from the comparison result, whether said burst transfer is suspended or not.

15. The data processor according to claim 1, further comprising:
a register to which permission or non-permission to suspend said burst transfer is set for each interrupt factor,
wherein said burst transfer is suspended only when said interrupt request has an interrupt factor that is set so as to permit suspension of said burst transfer.

16. The data processor according to claim 1 wherein
said interrupt instruction is executed after executing an instruction that is already fetched before an interrupt instruction corresponding to said interrupt request is fetched.

17. The data processor according to claim 1, wherein
instructions are processed in a pipeline having an instruction fetch stage fetching the instructions,
a decode stage decoding the instructions fetched by the instruction fetch stage and
an instruction execution stage executing the instructions decoded by the decoded stage, wherein
an interrupt process is performed when said interrupt request occurs, and
first and second processes are selectively performed in accordance with a priority of said interrupt request as the interrupt process,
said first process including a process that said instruction execution stage executing an interrupt instruction corresponding to said interrupt request after executing an instruction that is already fetched before the interrupt instruction is fetched by the instruction fetch stage, and
said second process including a process that said instruction stage executing the interrupt instruction before executing an instruction that is already fetched before the interrupt instruction is fetched by the instruction fetch stage and that is not yet executed by the instruction execution stage.

18. The data processor according to claim 17, further comprising:
a register to which a predetermined priority is set, and
a judgment unit comparing the priority of said interrupt request with the predetermined priority set in said register, and judging, from the comparison result, whether said first or second process is performed.

19. A data processor comprising:
a processor;
a first storage device; and
a second storage device connected between said processor and said first storage device,
wherein when a predetermined data required by said processor does not exist in said second storage device, a plurality of data corresponding to one line of said second storage device, including said predetermined data, are read from said first storage device and transferred to a certain line of said second storage device by burst transfer,
and when a first branch instruction is detected during a first burst transfer in the process of executing a first program, said first burst transfer is suspended and a second program as a branch target is executed,
said data processor further comprising a register for keeping a first information about a point at which said first burst transfer is suspended, wherein
upon completion of execution of said second program, said first burst transfer suspended is restarted based on said first information.

20. The data processor according to claim 19 wherein,
when a second branch instruction is detected during a second burst transfer in the process of executing said second program, said second burst transfer is suspended and a third program as a branch target is executed,
said data processor further comprising another register for keeping a second information about a point at which said second burst transfer is suspended, wherein
upon completion of execution of said third program, said second burst transfer suspended is restarted based on said second information.
